(19) United States
(12) Patent Application Publication
(10) Pub. No.: US 2022/0237667 A1
(43) Pub. Date: Jul. 28, 2022

(54) METHOD FOR MARKETING CONSUMER PRODUCTS BY PAIRING THEM WITH DRAMATIC PRESENTATION

(71) Applicant: PODPAIR, INC., MARCO ISLAND, FL (US)

(72) Inventor: Rebeca D. Seitz, Naples, FL (US)

(21) Appl. No.: 17/648,776

(22) Filed: Jan. 24, 2022

Related U.S. Application Data
(60) Provisional application No. 63/199,761, filed on Jan. 22, 2021.

(51) Int. Cl. G06Q 30/02

(52) U.S. Cl. CPC G06Q 30/0276

(57) ABSTRACT

A method of marketing and selling consumer goods pairings a consumer good with a dramatic story. The story is written to incorporate use of the consumer good within the dramatic story. A mechanism is provided for a consumer to purchase the consumer good before experiencing a presentation of the story. The consumer good is shipped to the consumer. The story is presented with cues encouraging the consumer to use the consumer good as they experience the presentation of the dramatic story. Additionally, a bundle of consumer goods related to the dramatic story may be created. A webpage includes a first hyperlink to order the bundle of goods and a second hyperlink that permits a user to play the presentation of the story, for example as a podcast.

### CROSS REFERENCE TO RELATED APPLICATION

This application claims priority under 35 U.S.C. § 119 to U.S. Provisional Application Ser. No. 63/199,761 filed Jan. 22, 2021, the entire contents of which are hereby incorporated by reference in their entirety.

### FIELD OF THE INVENTION

This invention relates generally to the field of marketing and more specifically to methods of marketing consumer products.

### BACKGROUND OF THE INVENTION

It is common to advertise for the sale of products during dramatic presentations such as televisions shows, radio broadcasts, or dramatic podcasts by including advertisements during breaks in the story. It is also known to promote goods by “product placement” within a dramatic story by showing a character using a promoted product within the dramatic presentation. However, these are generally passive promotions for the promoted goods that do not promote the products until the dramatic presentation is underway.

The promotion of the goods might be improved through a promotion that encourages purchase of the goods before the presentation and use or consumption of the goods during the presentation itself.

### BRIEF SUMMARY OF THE INVENTION

According to one embodiment, the present invention relates to a method of marketing and selling consumer goods by pairing a consumer good with a dramatic story; writing the dramatic story to incorporate use of the consumer good within the dramatic story; providing a mechanism for a consumer to purchase the consumer good before experiencing a presentation of the dramatic story; shipping the consumer good to the consumer; and presenting the dramatic story with cues encouraging the consumer to use the consumer good as they experience the presentation of the dramatic story. Additionally, a bundle of consumer goods related to the dramatic story may be created. The bundle of goods may be offered for sale and shipped to the consumer before the consumer experiences the presentation of the story. The story may be written with cues to use each of the goods of the bundle. A webpage may be created that includes a first hyperlink to order the bundle of goods and a second hyperlink that permits a user to play the presentation of the story.

### BRIEF DESCRIPTION OF THE DRAWINGS

FIG. 1 is a graphic representation of a webpage that includes a first link to permit a consumer to purchase consumer items associated with a dramatic story, including food and a candle, and a second link to permit the consumer to listen to a podcast of the dramatic story after receiving the consumer items.

FIG. 2 is a graphic representation of a webpage that includes a first link to permit a consumer to purchase a puzzle associated with a dramatic story and a second link to permit a consumer to listen to a podcast of the dramatic story.

FIG. 3 is a flow chart of a method of marketing and selling a consumer good according to one embodiment of the invention.

FIG. 4 is a flow chart of a method of marketing and selling a consumer good, including writing a story wherein a character interacts with the consumer good, according to another embodiment of the invention.

FIG. 5 is flow chart of a method of marketing and selling a consumer good, including recording a dramatic performance of a story that includes cues whereby a person experiencing the recorded performance is prompted to use the consumer good.

FIG. 6 is a perspective view of a consumer good box that includes a QR code that can be scanned to launch an application on a user's device that will permit a user to experience a story associated with the consumer good.

### DETAILED DESCRIPTION OF THE PREFERRED EMBODIMENT

The present invention relates to a method of marketing and selling consumer goods by pairing a consumer good with a dramatic story. The consumer good may be any good that might be purchased and used by a consumer. The dramatic story can be any type of story including romantic, humorous, musical, tragic or otherwise. In addition to increasing sales of the goods, the method also increases interest in and enjoyment of the presentation of the dramatic story. A user's experience of the dramatic story is enhanced by using or consuming the consumer good while experiencing the presentation of the story. Additionally, once a consumer good is purchased with the intent to use during experiencing a presentation of the story, the likelihood of the consumer experiencing the presentation is greatly increased. It also provides a way for fans to recommend or encourage acquaintances to experience a presentation by buying the consumer goods for their acquaintances.

Experience of the presentation may be by watching or listening to prerecorded or live enactments of the dramatic story. According to a preferred embodiment the presentation might be presented as a podcast that a user can stream over the Internet or save on a device for listening at a later date. Alternatively the presentation might be a television or radio broadcast, including over the airwaves, by cable television, or an Internet streaming service. Additionally, the presentation might be a live in-person presentation, such as a play in a theatre.

Preferably the consumer good will relate to the plot or actions of the story. For example, in a story set during the Christmas season the characters may attend a cookie exchange and the consumer good might be cookies that are the same kind as cookies offered at the cookie exchange. If characters meet over a cup of hot cocoa, the consumer good might be the same type hot cocoa as the characters drink. The user would then preferably be cued during the presentation to enjoy the cookies and cocoa at the same time as the characters in the story. In this way the user's enjoyment of the presentation is enhanced.

In other embodiments the consumer goods might relate to the story or characters in other ways. For example in a mystery story the user might be sent a kit that includes several clues that permit the user to attempt to solve the mystery as the user listens to or watches a presentation of the story. The mystery may occur over one or several episodes. In another embodiment the consumer good might be a jigsaw puzzle that includes an image or images of artwork that play a role in the story. The consumer good could be models or statues of the characters in the story that a user can paint to look how the user imagines the characters look.

In practice, a storyline is paired with one or more consumer goods. The story is written in a way that incorporates the consumer good in some fashion in the story. The story may be a completely original creation written with the specific purpose of being paired with a consumer good, may be an existing story that is altered to refer to or somehow incorporate the consumer good, or may be an existing story that already includes a reference to the consumer good. The story may be owned by the party that pairs the goods or may be licensed for the uses described herein. The goods are offered and promoted before the presentation of the story in a way that users will know that they will be able to enhance their enjoyment of the presentation if they obtain the consumer good before they experience the presentation of the story. For example an Internet webpage may be used that promotes both the presentation of the story and the purchase of the consumer goods. The webpage may include a hyperlink that permits a user to order the consumer goods over the Internet. The webpage may also include a hyperlink that permits a user to experience the story, for example as a podcast. Preferably the link that permits ordering the consumer good will be live and effective before the link that permits experiencing the presentation of the story. Alternatively, the a serialized presentation of the stories might occur on podcasts, television, or over the radio. In such an instance goods that are paired with future installments might be advertised or promoted during earlier episodes of the series, including information for how to purchase or order the goods before the corresponding episode is presented. Of course the presentation of the story may be made available in numerous other platforms and outlets apart from the pairing with the consumer goods such as Spotify, Apple Podcasts, iHeart Radio, Pandora and the like. The webpage that permits the user to purchase the consumer goods may include a hyperlink to one or more of the numerous platforms that permit experience of a presentation of the story, such as the aforementioned podcast providers, or other content providers such as television streams or video streams, such as Youtube.

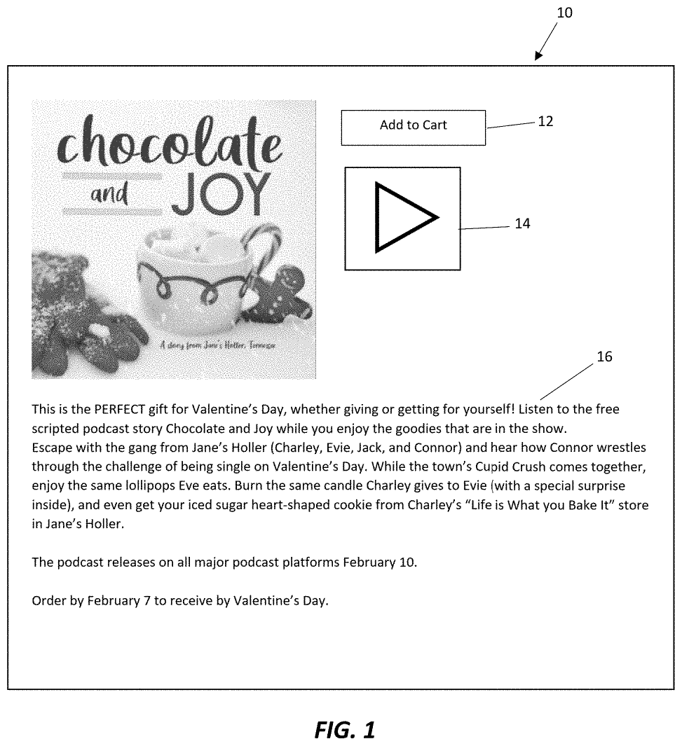

FIG. 1 shows an embodiment of a webpage 10 that offers consumer goods that will be associated with a story that will be presented as a podcast. Specifically, the webpage 10 offers for sale a box of consumer goods that will be associated with a story entitled “Chocolate and Joy”. The consumer goods within the box include a special lollipop and a cookie that will be related to the plot of the story. The consumer goods also include a scented candle and a decorative match box with strike matches for lighting the candle. The webpage includes a first link 12 to permit purchase of the box of consumer goods, which will be shipped to the user, preferably before the presentation of the story becomes available. The webpage also includes a second link 14 that permits the user to download and play the podcast when it becomes available. The webpage includes a description of the story and the associated consumer goods 16, as well as a suggestion to use the goods while experiencing a performance of the story. In this case that means eating the lollipop and cookies and lighting the candle with the matches. The user who receives the box and then plays the podcast can consume the lollipop and the cookie while listening to the podcast at the same time characters in the story interact with the lollipop and cookie. The user can light the candle and enjoy the aroma of the candle that is featured in the story. In this way the user's enjoyment of the presentation of the story is enhanced.

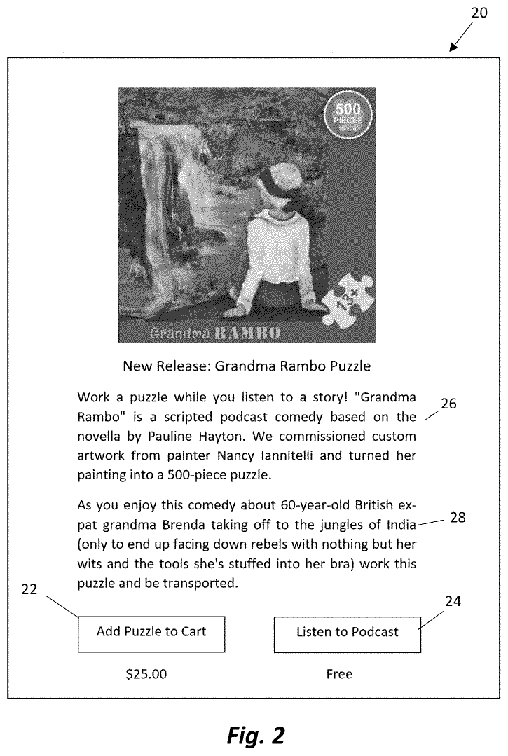

FIG. 2 shows an embodiment of a second webpage 20 that offers consumers the opportunity to purchase a puzzle related to a scripted comedy podcast. The webpage 20 includes a first hyperlink 22 that permits a user to order the puzzle. The webpage also includes a second hyperlink 24 that permits a consumer to listen to a podcast that relates to the puzzle. It should be understood that the second hyperlink may permit direct download or listening to the podcast related to the consumer product (in this case puzzle), or may lead to a third-party site or list of third-party sites that host presentations, such as podcasts. The webpage 20 also includes a short description of the consumer good 26 as well as a short description of the story 28 and a suggestion to use the consumer good while experiencing the story. In this case the suggestion to use the consumer good is to work the puzzle while listening to the podcast.

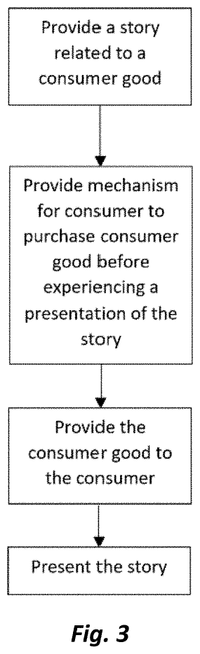

FIG. 3 shows a flow chart illustrating a method according to the present invention. The first step is to provide a story related to a consumer good. The story may be a completely original creation written with the specific purpose of being paired with a consumer good, may be an existing story that is altered to refer to or somehow incorporate the consumer good, or may be an existing story that already includes a reference to the consumer good. The story may be owned by the party that pairs the goods or may be licensed for the uses described herein. The consumer good may be nearly any item or service that can be used during listening or viewing of a dramatization of the story. The consumer good may be a consumable item, such as food, beverage of candle, or a more permanent item such as a puzzle, toy, craft, clothing, or other item. The second step is to provide a mechanism for consumers to obtain the consumer good before experiencing a presentation of the story. Commonly this might be by providing a link to an online order processing system operated by a third party, such as an Amazon or Shopify store, or by a self-created order system. The next step is to provide the good to the consumer, for example by shipping the good to the consumer or having a third party ship the good to the consumer. Finally, the story is presented to the consumer, for example by loading podcasts that can be accessed by the consumer after the consumer has the consumer good. Alternatively the presentation might be a television or radio broadcast, including over the airwaves, by cable television, or an Internet streaming service. Additionally, the presentation might be a live in-person presentation, such as a play in a theatre.

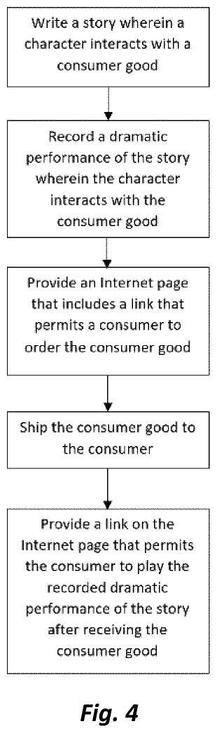

FIG. 4 shows another method according to the present invention wherein the first step is to write a story wherein a character in the story interacts with a consumer good. For example, a character might eat a cookie, give a toy to a friend, or light a scented candle. A recording of a dramatic performance is made. This recording might be audio-only, for example to be used as a podcast, or might include video recording as well. The dramatic performance should include the interaction between the character and the consumer good. An Internet page is provided (see for example FIGS. 1 and 2) the includes a link to permit a consumer to order the consumer good. The consumer good is then shipped to the consumer. A link is provided on a website to permit a consumer to play the recorded dramatic performance of the story after receiving the consumer good.

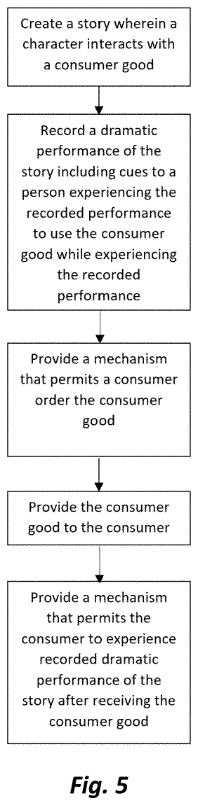

FIG. 5 shows yet another method according to the present invention. A story is created wherein at least one character interacts with a consumer good. A recording of a dramatic performance of the story is made wherein the performance includes a cue or cues for a person experiencing the dramatic performance to use the consumer good. A mechanism is provided, for example a website with a hyperlink, to permit a consumer to order the consumer good. The consumer good is then provided to the consumer who ordered the consumer good. Finally, a mechanism is provided that permits the consumer to experience the recorded dramatic performance after receiving the consumer good.

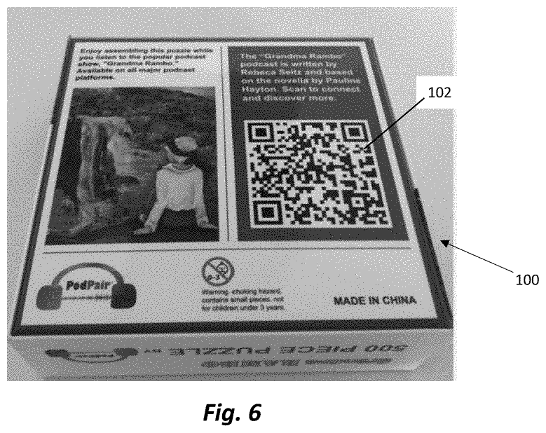

FIG. 6 shows a box for a consumer good 100, specifically the puzzle described in FIG. 2. The box 100 includes QR code 102. A consumer can scan the QR code using a personal device such as smart phone to launch an application that permits the user to experience a story related to the puzzle, as generally discussed above.

Additionally, it should be appreciated that the individual steps described above and shown in the Figures may be combined in various combinations.

This method is effective to market and promote both the consumer goods offered for sale and the presentation of the story. People who purchase the consumer goods in advance or receive them as gifts are very likely to watch or listen to a presentation of the story. Using the consumer goods enhances a user's connection to and enjoyment of the presentation of the story. Listening to or viewing the presentation of the story enhances the user's enjoyment of the consumer goods.

Accordingly, the present invention provides an improved method of marketing consumer goods by pairing the goods with a presentation of a dramatic story.

What is claimed is:

1. A method of marketing and selling consumer goods by pairing a consumer good with a dramatic story comprising:
providing a story that relates in some way to a consumer good;
providing a mechanism for a consumer to purchase the consumer good before experiencing a presentation of the story;
shipping the consumer good to the consumer; and
presenting the presentation of the story.

2. The method of claim 1, wherein the story includes a character that interacts with the consumer good.

3. The method of claim 2, wherein the consumer good is a food or beverage that is consumed by the character.

4. The method of claim 1 wherein the story is written to include cues to a user to use the consumer good at specific times while experiencing the presentation of the story.

5. The method of claim 1, wherein the presentation is a podcast of the story.

6. The method of claim 5, further comprising providing an Internet page that includes a link that permits purchase of the consumer good.

7. The method of claim 6, wherein the Internet page includes a link that permits downloading or streaming of the podcast.

8. The method of claim 1, wherein the story is written to relate in some way to a second consumer good and wherein the consumer good and the second consumer good are bundled together and shipped to a user.

9. The method of claim 1, further comprising creating the story.
